(19) United States
(12) Patent Application Publication
(10) Pub. No.: US 2023/0055641 A1
(43) Pub. Date: Feb. 23, 2023

(54) REAL-TIME GENERATION OF DIGITAL TWINS BASED ON INPUT DATA CAPTURED BY USER DEVICE

(71) Applicant: Honeywell International Inc., Charlotte, NC (US)

(72) Inventor: Arun Srinivasan PRASATH, Suwanee, GA (US)

(21) Appl. No.: 17/887,240

(22) Filed: Aug. 12, 2022

Related U.S. Application Data
(60) Provisional application No. 63/260,333, filed on Aug. 17, 2021.

(51) Int. Cl. G06Q 10/06; G06F 9/451

(52) U.S. Cl. CPC G06Q 10/067; G06F 9/451

(57) ABSTRACT

Various embodiments described herein relate to real-time generation of digital twins using asset data captured from a user device. In this regard, input data is received and one or more attributes of an asset are determined based on the input data. In accordance with determining whether the one or more attributes satisfy a predefined threshold, a digital twin or suggested digital twin is generated. Data associated with the digital twin or suggested digital twin is presented at a user interface of the user device enabling a user to extend or modify the data.

### CROSS REFERENCE TO RELATED APPLICATIONS

This application claims the benefit of U.S. Provisional Patent Application No. 63/260,333, titled “REAL-TIME GENERATION OF DIGITAL TWINS BASED ON INPUT DATA CAPTURED BY USER DEVICE,” and filed on Aug. 17, 2021, the entirety of which is hereby incorporated by reference.

### TECHNICAL FIELD

The present disclosure relates generally to real-time asset management, and more particularly to real-time generation of digital twins using asset data captured from a user device

### BACKGROUND

Various industries include a large amount of assets, such as interconnected devices and/or equipment at one or multiple asset sites, such as industrial plants, warehouses, and/or buildings. Such industries may monitor and gauge efficiency of their respective assets and/or confirm that the assets are functioning properly by utilizing a digital representation of their respective assets for performing data analytics and/or other processes related to the assets.

Discovery of assets and collection of asset data in order to generate models to represent the assets digitally is challenging and time-consuming in circumstances wherein a large plurality of assets such as equipment, controllers, devices, sensors and/or the like originate from different vendors and/or have been in use and on-premises for an extended period of time.

### BRIEF SUMMARY

In accordance with some embodiments, a method is performed. The method includes receiving input data associated with an asset. The method also includes determining one or more attributes of the asset based at least on the input data. The method also includes determining whether the one or more attributes satisfy a predefined threshold associated with a stored asset data unit based at least on querying an asset database. The method also includes, in accordance with a determination that the one or more attributes do not satisfy the predefined threshold, accessing sensor data associated with the asset. The method also includes generating, based at least on the sensor data and the one or more attributes, a suggested digital twin of the asset. The method also includes causing presentation, via a user interface, of data associated with the suggested digital twin of the asset at a user device.

In some embodiments, the method also includes, in accordance with a determination that the one or more attributes satisfy the predefined threshold, generating a digital twin of the asset based at least on the stored asset data unit. In some embodiments, the method also includes generating a second digital twin of a second asset. In some embodiments, the method also includes storing the digital twin of the asset in association with at least the second digital twin of a shared asset site.

In some embodiments, the method also includes causing presentation, via the user interface, of data associated with the digital twin of the asset.

In some embodiments of the method, generating of the suggested digital twin comprises applying the sensor data and the one or more attributes to a contextual discovery model to determine one or more suggested digital twins of the asset.

In some embodiments, the method also includes providing new data associated with a determination that the one or more attributes satisfy the predefined threshold to train the contextual discovery model.

In some embodiments, the method also includes receiving, via input to the user interface, an extension of the digital twin or the suggested digital twin. In some embodiments, the method also includes modifying the digital twin or the suggested digital twin based on the extension.

In some embodiments of the method, the input data is received from the user device. In some embodiments of the method, the input data comprises image data captured by the user device. In some embodiments of the method, the image data comprises an image of indicia associated with the asset. In some embodiments of the method, the input data comprises sound data captured by the user device.

In some embodiments, the method also includes determining a location of the asset based at least on location data associated with the user device.

In some embodiments, the method also includes generating a geospatial plan of an asset site associated with the asset, the geospatial plan comprising location data of a plurality of assets within the asset site.

In accordance with some embodiments, a system is provided. The system includes a processor and a memory that stores executable instructions that, when executed by the processor, cause the processor to receive input data associated with an asset. The executable instructions, when executed by the processor, also cause the processor to determine one or more attributes of the asset based at least on the input data. The executable instructions, when executed by the processor, also cause the processor to determine whether the one or more attributes satisfy a predefined threshold associated with a stored asset data unit based at least on querying an asset database. The executable instructions, when executed by the processor, also cause the processor to, in accordance with a determination that the one or more attributes do not satisfy the predefined threshold, access sensor data associated with the asset. The executable instructions, when executed by the processor, also cause the processor to, based at least on the sensor data and the one or more attributes, generate a suggested digital twin of the asset. The executable instructions, when executed by the processor, also cause the processor to cause presentation, via a user interface, of data associated with the suggested digital twin of the asset at a user device.

In some embodiments, the executable instructions are further configured to, when executed by the processor, cause the processor to, in accordance with a determination that the one or more attributes satisfy the predefined threshold, generate a digital twin of the asset based at least on the stored asset data unit. In some embodiments, the executable instructions are further configured to, when executed by the processor, cause the processor to generate a second digital twin of a second asset. In some embodiments, the executable instructions are further configured to, when executed by the processor, cause the processor to store the digital twin of the asset in association with at least the second digital twin of a shared asset site.

In some embodiments, the executable instructions are further configured to, when executed by the processor, cause the processor to cause presentation, via the user interface, of data associated with the digital twin of the asset.

In some embodiments of the system, the executable instructions configured to generate the suggested digital twin are further configured to, when executed by the processor, cause the processor to apply the sensor data and the one or more attributes to a contextual discovery model to determine one or more suggested digital twins of the asset.

In some embodiments, the executable instructions are further configured to, when executed by the processor, cause the processor to provide new data associated with a determination that the one or more attributes satisfy the predefined threshold to train the contextual discovery model.

In some embodiments, the executable instructions are further configured to, when executed by the processor, cause the processor to receive, via input to the user interface, an extension of the digital twin or the suggested digital twin. In some embodiments, the executable instructions are further configured to, when executed by the processor, cause the processor to modify the digital twin or the suggested digital twin based on the extension.

In some embodiments of the system, the input data is received from the user device. In some embodiments of the system, the input data comprises image data captured by the user device. In some embodiments of the system, the image data comprises an image of indicia associated with the asset. In some embodiments of the system, the input data comprises sound data captured by the user device.

In some embodiments, the executable instructions are further configured to, when executed by the processor, cause the processor to determine a location of the asset based at least on location data associated with the user device.

In some embodiments, the executable instructions are further configured to, when executed by the processor, cause the processor to generate a geospatial plan of an asset site associated with the asset, the geospatial plan comprising location data of a plurality of assets within the asset site.

In accordance with some embodiments, a non-transitory computer-readable storage medium is provided. The non-transitory computer-readable storage medium includes one or more programs for execution by one or more processors of a first device. The one or more programs include instructions which, when executed by the one or more processors, cause the device to receive input data associated with an asset. The one or more programs also include instructions which, when executed by the one or more processors, cause the device to determine one or more attributes of the asset based at least on the input data. The one or more programs also include instructions which, when executed by the one or more processors, cause the device to determine whether the one or more attributes satisfy a predefined threshold associated with a stored asset data unit based at least on querying an asset database. The one or more programs also include instructions which, when executed by the one or more processors, cause the device to, in accordance with a determination that the one or more attributes do not satisfy the predefined threshold, access sensor data associated with the asset. The one or more programs also include instructions which, when executed by the one or more processors, cause the device to, based at least on the sensor data and the one or more attributes, generate a suggested digital twin of the asset. The one or more programs also include instructions which, when executed by the one or more processors, cause the device to cause presentation, via a user interface, of data associated with the suggested digital twin of the asset at a user device.

In some embodiments, the one or more programs also include instructions which, when executed by the one or more processors, cause the device to, in accordance with a determination that the one or more attributes satisfy the predefined threshold, generate a digital twin of the asset based at least on the stored asset data unit. In some embodiments, the one or more programs also include instructions which, when executed by the one or more processors, cause the device to generate a second digital twin of a second asset. In some embodiments, the one or more programs also include instructions which, when executed by the one or more processors, cause the device to store the digital twin of the asset in association with at least the second digital twin of a shared asset site.

In some embodiments, the one or more programs also include instructions which, when executed by the one or more processors, cause the device to cause presentation, via the user interface, of data associated with the digital twin of the asset.

In some embodiments of the non-transitory computer-readable storage medium, the instructions which, when executed by the one or more processors, cause the device to generate the suggested digital twin also cause the device to apply the sensor data and the one or more attributes to a contextual discovery model to determine one or more suggested digital twins of the asset.

In some embodiments, the one or more programs also include instructions which, when executed by the one or more processors, cause the device to provide new data associated with a determination that the one or more attributes satisfy the predefined threshold to train the contextual discovery model.

In some embodiments, the one or more programs also include instructions which, when executed by the one or more processors, cause the device to receive, via input to the user interface, an extension of the digital twin or the suggested digital twin. In some embodiments, the one or more programs also include instructions which, when executed by the one or more processors, cause the device to modify the digital twin or the suggested digital twin based on the extension.

In some embodiments of the non-transitory computer-readable storage medium, the input data is received from the user device. In some embodiments of the non-transitory computer-readable storage medium, the input data comprises image data captured by the user device. In some embodiments of the non-transitory computer-readable storage medium, the image data comprises an image of indicia associated with the asset. In some embodiments of the non-transitory computer-readable storage medium, the input data comprises sound data captured by the user device.

In some embodiments, the one or more programs also include instructions which, when executed by the one or more processors, cause the device to determine a location of the asset based at least on location data associated with the user device.

In some embodiments, the one or more programs also include instructions which, when executed by the one or more processors, cause the device to generate a geospatial plan of an asset site associated with the asset, the geospatial plan comprising location data of a plurality of assets within the asset site.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary networked computing system environment, according to one or more embodiments;

FIG. 2 depicts a schematic block diagram of a framework of an Internet of Things (IoT) platform of the networked computing system environment of FIG. 1;

FIG. 3 depicts an example system that executes techniques presented herein;

FIG. 4 illustrates a flow diagram of operations related to determining and generating a digital twin or suggested digital twin based on receiving input data, in accordance with one or more embodiments described herein;

FIG. 5 illustrates a flow diagram of operations related to determining and generating a suggested digital twin based on accessing sensor data, in accordance with one or more embodiments described herein;

FIG. 6 illustrates a flow diagram of operations related to determining and generating a digital twin, in accordance with one or more embodiments described herein;

FIG. 7 illustrates a flow diagram of operations related to an extension of a digital twin or suggested digital twin, in accordance with one or more embodiments described herein; and

FIG. 8 illustrates a flow diagram of operations related to determining location data and generating a geospatial plan of an asset site, in accordance with one or more embodiments described herein.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. The word “exemplary” is used herein to mean “serving as an example, instance, or illustration.” Any implementation described herein as “exemplary” is not necessarily to be construed as preferred or advantageous over other implementations. Like numbers refer to like elements throughout.

The phrases “in an embodiment,” “in one embodiment,” “according to one embodiment,” and the like generally mean that the particular feature, structure, or characteristic following the phrase can be included in at least one embodiment of the present disclosure, and can be included in more than one embodiment of the present disclosure (importantly, such phrases do not necessarily refer to the same embodiment).

If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some embodiments, or it can be excluded.

In general, the present disclosure provides for an “Internet-of-Things” or “IoT” platform for enterprise performance management that uses real-time accurate models and visual analytics to deliver intelligent actionable recommendations for sustained peak performance of an enterprise or organization. The IoT platform is an extensible platform that is portable for deployment in any cloud or data center environment for providing an enterprise-wide, top to bottom view, displaying the status of processes, assets, people, and safety. Further, the IoT platform of the present disclosure supports end-to-end capability to execute digital twins against process data and to translate the output into actionable insights, as detailed in the following description.

As described above, an industrial plant, connected warehouse, building and/or the like containing a vast amount of assets and an associated automation system for the assets can be complex and may comprise tens of thousands of data points of sensors, controllers, actuators, and/or the like. For this reason, systems and methods comprising functionalities such as analytics, predictive maintenance models, fault detection processes, model-based predictive control algorithms, and/or the like, can be built and deployed to process time-series data of the assets in order to diagnose various conditions of the asset system, predict faults within the asset system, optimize performance, gain various insights, monitor productivity and/or performance, and/or the like.

Such systems and methods may be associated with a digital or semantic model, also referred to as a digital twin, for the assets. Such digital twins represent and describe the arrangement of real-world assets and provide context for those assets. A digital twin is defined with a common vocabulary (e.g., terminology for various assets, properties, and/or the like) and established by a formal domain model (e.g., a domain ontology). Digital twins can be used to allow for the analysis of devices or performing analytics and/or customized manual programming for assets, including but not limited to advanced diagnostics, energy management, performance optimization, and/or the like.

However, onboarding various assets into a digital twin or model of an asset, such as identifying precisely what role the respective assets play within the asset site, how the respective assets are interconnected, what data the respective assets utilize and/or provide, the locations of respective assets, and/or the like presents a challenge site in situations such wherein asset site contains an assortment of both older and newer generation assets which were manufactured by a plurality of different vendors. In this regard, additional time is needed to accurately account for how the assets should be represented as a digital twin, leading to a slower onboarding speed of the asset site and potential for faults of various assets going undetected for an extended period.

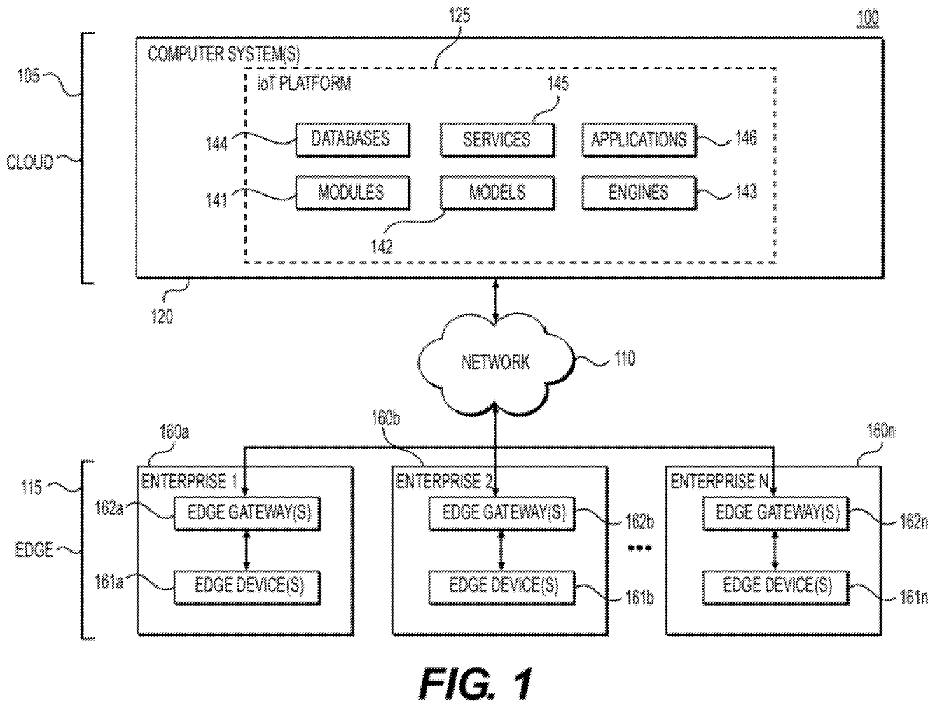

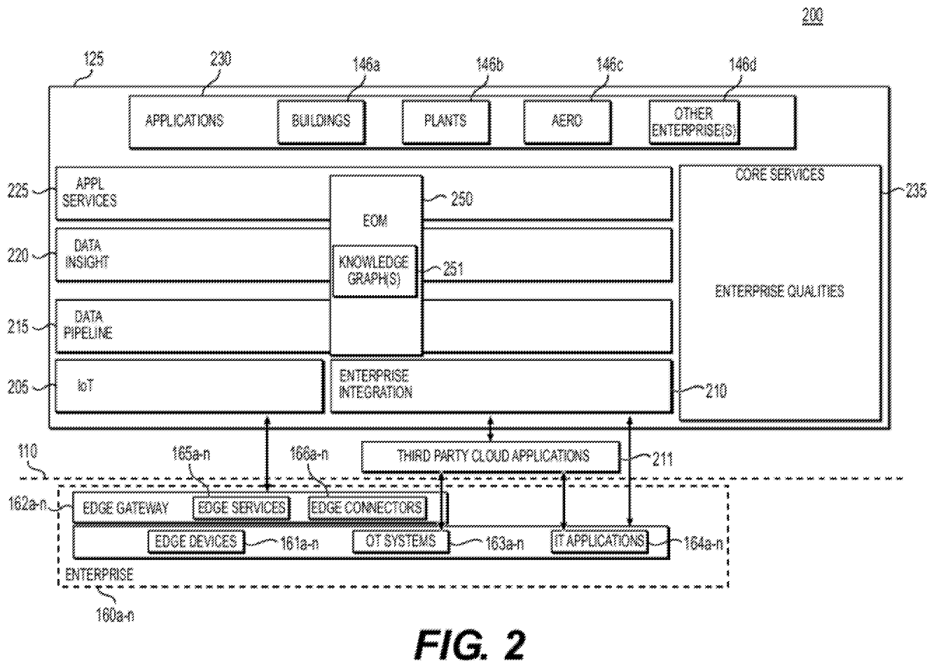

To address these and/or other issues, a system, method, and computer-readable medium are provided that determine and generate a digital twin of an asset in real-time or near real-time based on input data, such as image data or sound data received from a user device. In various embodiments, a digital twin is determined and generated by leveraging cloud-based services of an Internet-of-Things (IoT) platform (described further below in connection with FIGS. 1 and 2). As a result and in some examples, the system, method, and computer-readable medium disclosed herein improves onboarding speed, improves accuracy of the digital twin (e.g., such as improved accuracy with respect to the asset), includes improved geo-location data for the asset, includes additional information about the asset (e.g., serviceability), provides traceability of the root of manufacturing, and/or is configured to automatically map the geo-located digital twin.

In various embodiments, attributes of an asset are determined based on the input data, and a query is made to an asset database to determine whether the attributes satisfy a predefined threshold associated with a stored asset data unit. In various embodiments, based on the predefined threshold being satisfied, a digital twin is then generated and data associated with the digital twin is then presented via a user interface at the user device. In various embodiments, a user is enabled to extend (e.g., modify or add to) the digital twin of the asset through input via the user interface. In this regard, in various embodiments, users may define additional properties or attributes of the asset, modify data associated with the asset such as measurement data, input or output data, a name or names of properties of the asset, and/or the like. In various embodiments, data resulting in a successful identification of the asset (e.g., in instances in which the predefined threshold is satisfied) is utilized as additional training data to a contextual discovery model.

In various embodiments, based on the predefined threshold not being satisfied, the contextual discovery model is utilized to determine and generate a suggested digital twin, and data associated with the suggested digital twin is then presented via a user interface at the user device. In various embodiments, the suggested digital twin is generated based further on sensor data associated with the asset. For example, in addition to the input data and one or more attributes derived from the input data, sensor data received via one or more sensors associated with the asset may be utilized by the contextual discovery model to determine a suggested digital twin representing what the asset most likely is and what data is associated with the asset. In various embodiments, a user is enabled to extend the suggested digital twin of the asset through input via the user interface.

In various embodiments, a location of the asset is determined based on location data associated with the user device. In various embodiments, using location data collected for assets of an asset site, a geospatial plan of the asset site is generated. In various embodiments, the geospatial plan comprises location data of a plurality of assets within the asset site and provides a visualization of a layout of the assets within the asset site.

FIG. 1 illustrates an exemplary networked computing system environment 100, according to the present disclosure. As shown in FIG. 1, networked computing system environment 100 is organized into a plurality of layers including a cloud layer 105, a network layer 110, and an edge layer 115. As detailed further below, components of the edge 115 are in communication with components of the cloud 105 via network 110.

In various embodiments, network 110 is any suitable network or combination of networks and supports any appropriate protocol suitable for communication of data to and from components of the cloud 105 and between various other components in the networked computing system environment 100 (e.g., components of the edge 115). According to various embodiments, network 110 includes a public network (e.g., the Internet), a private network (e.g., a network within an organization), or a combination of public and/or private networks. According to various embodiments, network 110 is configured to provide communication between various components depicted in FIG. 1. According to various embodiments, network 110 comprises one or more networks that connect devices and/or components in the network layout to allow communication between the devices and/or components. For example, in one or more embodiments, the network 110 is implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, network 110 is implemented using cellular networks, satellite, licensed radio, or a combination of cellular, satellite, licensed radio, and/or unlicensed radio networks.

Components of the cloud 105 include one or more computer systems 120 that form a so-called “Internet-of-Things” or “IoT” platform 125. It should be appreciated that “IoT platform” is an optional term describing a platform connecting any type of Internet-connected device, and should not be construed as limiting on the types of computing systems useable within IoT platform 125. In particular, in various embodiments, computer systems 120 includes any type or quantity of one or more processors and one or more data storage devices comprising memory for storing and executing applications or software modules of networked computing system environment 100. In one embodiment, the processors and data storage devices are embodied in server-class hardware, such as enterprise-level servers. For example, in an embodiment, the processors and data storage devices comprise any type or combination of application servers, communication servers, web servers, super-computing servers, database servers, file servers, mail servers, proxy servers, and/or virtual servers. Further, the one or more processors are configured to access the memory and execute processor-readable instructions, which when executed by the processors configures the processors to perform a plurality of functions of the networked computing system environment 100.

Computer systems 120 further include one or more software components of the IoT platform 125. For example, in one or more embodiments, the software components of computer systems 120 include one or more software modules to communicate with user devices and/or other computing devices through network 110. For example, in one or more embodiments, the software components include one or more modules 141, models 142, engines 143, databases 144, services 145, and/or applications 146, which may be stored in/by the computer systems 120 (e.g., stored on the memory), as detailed with respect to FIG. 2 below. According to various embodiments, the one or more processors are configured to utilize the one or more modules 141, models 142, engines 143, databases 144, services 145, and/or applications 146 when performing various methods described in this disclosure.

Accordingly, in one or more embodiments, computer systems 120 execute a cloud computing platform (e.g., IoT platform 125) with scalable resources for computation and/or data storage, and may run one or more applications on the cloud computing platform to perform various computer-implemented methods described in this disclosure. In some embodiments, some of the modules 141, models 142, engines 143, databases 144, services 145, and/or applications 146 are combined to form fewer modules, models, engines, databases, services, and/or applications. In some embodiments, some of the modules 141, models 142, engines 143, databases 144, services 145, and/or applications 146 are separated into separate, more numerous modules, models, engines, databases, services, and/or applications. In some embodiments, some of the modules 141, models 142, engines 143, databases 144, services 145, and/or applications 146 are removed while others are added.

The computer systems 120 are configured to receive data from other components (e.g., components of the edge 115) of networked computing system environment 100 via network 110. Computer systems 120 are further configured to utilize the received data to produce a result. According to various embodiments, information indicating the result is transmitted to users via user computing devices over network 110. In some embodiments, the computer systems 120 is a server system that provides one or more services including providing the information indicating the received data and/or the result(s) to the users. According to various embodiments, computer systems 120 are part of an entity which include any type of company, organization, or institution that implements one or more IoT services. In some examples, the entity is an IoT platform provider.

Components of the edge 115 include one or more enterprises 160a-160n each including one or more edge devices 161a-161n and one or more edge gateways 162a-162n. For example, a first enterprise 160a includes first edge devices 161a and first edge gateways 162a, a second enterprise 160b includes second edge devices 161b and second edge gateways 162b, and an nth enterprise 160n includes nth edge devices 161n and nth edge gateways 162n. As used herein, enterprises 160a-160n represent any type of entity, facility, or vehicle, such as, for example, companies, divisions, buildings, manufacturing plants, warehouses, real estate facilities, laboratories, aircraft, spacecraft, automobiles, ships, boats, military vehicles, oil and gas facilities, or any other type of entity, facility, and/or entity that includes any number of local devices.

According to various embodiments, the edge devices 161a-161n represent any of a variety of different types of devices that may be found within the enterprises 160a-160n. Edge devices 161a-161n are any type of device configured to access network 110, or be accessed by other devices through network 110, such as via an edge gateway 162a-162n. According to various embodiments, edge devices 161a-161n are “IoT devices” which include any type of network-connected (e.g., Internet-connected) device. For example, in one or more embodiments, the edge devices 161a-161n include assets, sensors, actuators, processors, computers, valves, pumps, ducts, vehicle components, cameras, displays, doors, windows, security components, boilers, chillers, pumps, HVAC components, factory equipment, and/or any other devices that are connected to the network 110 for collecting, sending, and/or receiving information. Each edge device 161a-161n includes, or is otherwise in communication with, one or more controllers for selectively controlling a respective edge device 161a-161n and/or for sending/receiving information between the edge devices 161a-161n and the cloud 105 via network 110. With reference to FIG. 2, in one or more embodiments, the edge 115 include operational technology (OT) systems 163a-163n and information technology (IT) applications 164a-164n of each enterprise 161a-161n. The OT systems 163a-163n include hardware and software for detecting and/or causing a change, through the direct monitoring and/or control of industrial equipment (e.g., edge devices 161a-161n), assets, processes, and/or events. The IT applications 164a-164n includes network, storage, and computing resources for the generation, management, storage, and delivery of data throughout and between organizations.

The edge gateways 162a-162n include devices for facilitating communication between the edge devices 161a-161n and the cloud 105 via network 110. For example, the edge gateways 162a-162n include one or more communication interfaces for communicating with the edge devices 161a-161n and for communicating with the cloud 105 via network 110. According to various embodiments, the communication interfaces of the edge gateways 162a-162n include one or more cellular radios, Bluetooth, WiFi, near-field communication radios, Ethernet, or other appropriate communication devices for transmitting and receiving information. According to various embodiments, multiple communication interfaces are included in each gateway 162a-162n for providing multiple forms of communication between the edge devices 161a-161n, the gateways 162a-162n, and the cloud 105 via network 110. For example, in one or more embodiments, communication are achieved with the edge devices 161a-161n and/or the network 110 through wireless communication (e.g., WiFi, radio communication, etc.) and/or a wired data connection (e.g., a universal serial bus, an onboard diagnostic system, etc.) or other communication modes, such as a local area network (LAN), wide area network (WAN) such as the Internet, a telecommunications network, a data network, or any other type of network.

According to various embodiments, the edge gateways 162a-162n also include a processor and memory for storing and executing program instructions to facilitate data processing. For example, in one or more embodiments, the edge gateways 162a-162n are configured to receive data from the edge devices 161a-161n and process the data prior to sending the data to the cloud 105. Accordingly, in one or more embodiments, the edge gateways 162a-162n include one or more software modules or components for providing data processing services and/or other services or methods of the present disclosure. With reference to FIG. 2, each edge gateway 162a-162n includes edge services 165a-165n and edge connectors 166a-166n. According to various embodiments, the edge services 165a-165n include hardware and software components for processing the data from the edge devices 161a-161n. According to various embodiments, the edge connectors 166a-166n include hardware and software components for facilitating communication between the edge gateway 162a-162n and the cloud 105 via network 110, as detailed above. In some cases, any of edge devices 161a-n, edge connectors 166a-n, and edge gateways 162a-n have their functionality combined, omitted, or separated into any combination of devices. In other words, an edge device and its connector and gateway need not necessarily be discrete devices.

FIG. 2 illustrates a schematic block diagram of framework 200 of the IoT platform 125, according to the present disclosure. The IoT platform 125 of the present disclosure is a platform for enterprise performance management that uses real-time accurate models and visual analytics to deliver intelligent actionable recommendations for sustained peak performance of the enterprise 160a-160n. The IoT platform 125 is an extensible platform that is portable for deployment in any cloud or data center environment for providing an enterprise-wide, top to bottom view, displaying the status of processes, assets, people, and safety. Further, the IoT platform 125 supports end-to-end capability to execute digital twins against process data and to translate the output into actionable insights, using the framework 200, detailed further below.

As shown in FIG. 2, the framework 200 of the IoT platform 125 comprises a number of layers including, for example, an IoT layer 205, an enterprise integration layer 210, a data pipeline layer 215, a data insight layer 220, an application services layer 225, and an applications layer 230. The IoT platform 125 also includes a core services layer 235 and an extensible object model (EOM) 250 comprising one or more knowledge graphs 251. The layers 205-235 further include various software components that together form each layer 205-235. For example, each layer 205-235 may include one or more of the modules 141, models 142, engines 143, databases 144, services 145, applications 146, or combinations thereof. In some embodiments, the layers 205-235 may be combined to form fewer layers. In some embodiments, some of the layers 205-235 may be separated into separate, more numerous layers. In some embodiments, some of the layers 205-235 may be removed while others may be added.

The IoT platform 125 is a model-driven architecture. Thus, the extensible object model 250 communicates with each layer 205-230 to contextualize site data of the enterprise 160a-160n using an extensible object model (or “asset model”) and knowledge graphs 251 where the equipment (e.g., edge devices 161a-161n) and processes of the enterprise 160a-160n are modeled. The knowledge graphs 251 of EOM 250 are configured to store the models in a central location. The knowledge graphs 251 define a collection of nodes and links that describe real-world connections that enable smart systems. As used herein, a knowledge graph 251: (i) describes real-world entities (e.g., edge devices 161a-161n) and their interrelations organized in a graphical interface; (ii) defines possible classes and relations of entities in a schema; (iii) enables interrelating arbitrary entities with each other; and (iv) covers various topical domains. In other words, the knowledge graphs 251 define large networks of entities (e.g., edge devices 161a-161n), semantic types of the entities, properties of the entities, and relationships between the entities. Thus, the knowledge graphs 251 describe a network of “things” that are relevant to a specific domain or to an enterprise or organization. Knowledge graphs 251 are not limited to abstract concepts and relations, but can also contain instances of objects, such as, for example, documents and datasets. In some embodiments, the knowledge graphs 251 may include resource description framework (RDF) graphs. As used herein, a “RDF graph” is a graph data model that formally describes the semantics, or meaning, of information. The RDF graph can also represent metadata (e.g., data that describes data). Knowledge graphs 251 can also include a semantic object model. The semantic object model is a subset of a knowledge graph 251 that defines semantics for the knowledge graph 251. For example, the semantic object model defines the schema for the knowledge graph 251.

As used herein, EOM 250 is a collection of application programming interfaces (APIs) that enables seeded semantic object models to be extended. For example, the EOM 250 of the present disclosure enables a customer's knowledge graph 251 to be built subject to constraints expressed in the customer's semantic object model. Thus, the knowledge graphs 251 are generated by customers (e.g., enterprises or organizations) to create models of the edge devices 161a-161n of an enterprise 160a-160n, and the knowledge graphs 251 are input into the EOM 250 for visualizing the models (e.g., the nodes and links).

The models describe the assets (e.g., the nodes) of an enterprise (e.g., the edge devices 161a-161n) and describe the relationship of the assets with other components (e.g., the links). The models also describe the schema (e.g., describe what the data is), and therefore the models are self-validating. For example, the model can describe the type of sensors mounted on any given asset (e.g., edge device 161a-161n) and the type of data that is being sensed by each sensor. A key performance indicator (KPI) framework can be used to bind properties of the assets in the extensible object model 250 to inputs of the KPI framework. Accordingly, the IoT platform 125 is an extensible, model-driven end-to-end stack including: two-way model sync and secure data exchange between the edge 115 and the cloud 105, metadata driven data processing (e.g., rules, calculations, and aggregations), and model driven visualizations and applications. As used herein, “extensible” refers to the ability to extend a data model to include new properties/columns/fields, new classes/tables, and new relations. Thus, the IoT platform 125 is extensible with regards to edge devices 161a-161n and the applications 146 that handle those devices 161a-161n. For example, when new edge devices 161a-161n are added to an enterprise 160a-160n system, the new devices 161a-161n will automatically appear in the IoT platform 125 so that the corresponding applications 146 can understand and use the data from the new devices 161a-161n.

In some cases, asset templates are used to facilitate configuration of instances of edge devices 161a-161n in the model using common structures. An asset template defines the typical properties for the edge devices 161a-161n of a given enterprise 160a-160n for a certain type of device. For example, an asset template of a pump includes modeling the pump having inlet and outlet pressures, speed, flow, etc. The templates may also include hierarchical or derived types of edge devices 161a-161n to accommodate variations of a base type of device 161a-161n. For example, a reciprocating pump is a specialization of a base pump type and would include additional properties in the template. Instances of the edge device 161a-161n in the model are configured to match the actual, physical devices of the enterprise 160a-160n using the templates to define expected attributes of the device 161a-161n. Each attribute is configured either as a static value (e.g., capacity is 1000 BPH) or with a reference to a time series tag that provides the value. The knowledge graph 251 can automatically map the tag to the attribute based on naming conventions, parsing, and matching the tag and attribute descriptions and/or by comparing the behavior of the time series data with expected behavior.

The modeling phase includes an onboarding process for syncing the models between the edge 115 and the cloud 105. For example, the onboarding process can include a simple onboarding process, a complex onboarding process, and/or a standardized rollout process. The simple onboarding process includes the knowledge graph 251 receiving raw model data from the edge 115 and running context discovery algorithms to generate the model. The context discovery algorithms read the context of the edge naming conventions of the edge devices 161a-161n and determine what the naming conventions refer to. For example, the knowledge graph 251 can receive “TMP” during the modeling phase and determine that “TMP” relates to “temperature.” The generated models are then published. The complex onboarding process includes the knowledge graph 251 receiving the raw model data, receiving point history data, and receiving site survey data. The knowledge graph 251 can then use these inputs to run the context discovery algorithms. The generated models can be edited and then the models are published. The standardized rollout process includes manually defining standard models in the cloud 105 and pushing the models to the edge 115.

The IoT layer 205 includes one or more components for device management, data ingest, and/or command/control of the edge devices 161a-161n. The components of the IoT layer 205 enable data to be ingested into, or otherwise received at, the IoT platform 125 from a variety of sources. For example, data can be ingested from the edge devices 161a-161n through process historians or laboratory information management systems. The IoT layer 205 is in communication with the edge connectors 165a-165n installed on the edge gateways 162a-162n through network 110, and the edge connectors 165a-165n send the data securely to the IoT platform 205. In some embodiments, only authorized data is sent to the IoT platform 125, and the IoT platform 125 only accepts data from authorized edge gateways 162a-162n and/or edge devices 161a-161n. Data may be sent from the edge gateways 162a-162n to the IoT platform 125 via direct streaming and/or via batch delivery. Further, after any network or system outage, data transfer will resume once communication is re-established and any data missed during the outage will be backfilled from the source system or from a cache of the IoT platform 125. The IoT layer 205 may also include components for accessing time series, alarms and events, and transactional data via a variety of protocols.

The enterprise integration layer 210 includes one or more components for events/messaging, file upload, and/or REST/OData. The components of the enterprise integration layer 210 enable the IoT platform 125 to communicate with third party cloud applications 211, such as any application(s) operated by an enterprise in relation to its edge devices. For example, the enterprise integration layer 210 connects with enterprise databases, such as guest databases, customer databases, financial databases, patient databases, etc. The enterprise integration layer 210 provides a standard application programming interface (API) to third parties for accessing the IoT platform 125. The enterprise integration layer 210 also enables the IoT platform 125 to communicate with the OT systems 163a-163n and IT applications 164a-164n of the enterprise 160a-160n. Thus, the enterprise integration layer 210 enables the IoT platform 125 to receive data from the third party applications 211 rather than, or in combination with, receiving the data from the edge devices 161a-161n directly.

The data pipeline layer 215 includes one or more components for data cleansing/enriching, data transformation, data calculations/aggregations, and/or API for data streams. Accordingly, the data pipeline layer 215 can pre-process and/or perform initial analytics on the received data. The data pipeline layer 215 executes advanced data cleansing routines including, for example, data correction, mass balance reconciliation, data conditioning, component balancing and simulation to ensure the desired information is used as a basis for further processing. The data pipeline layer 215 also provides advanced and fast computation. For example, cleansed data is run through enterprise-specific digital twins. The enterprise-specific digital twins can include a reliability advisor containing process models to determine the current operation and the fault models to trigger any early detection and determine an appropriate resolution. The digital twins can also include an optimization advisor that integrates real-time economic data with real-time process data, selects the right feed for a process, and determines optimal process conditions and product yields.

The data pipeline layer 215 may also use models and templates to define calculations and analytics, and define how the calculations and analytics relate to the assets (e.g., the edge devices 161a-161n). For example, a pump template can define pump efficiency calculations such that every time a pump is configured, the standard efficiency calculation is automatically executed for the pump. The calculation model defines the various types of calculations, the type of engine that should run the calculations, the input and output parameters, the preprocessing requirement and prerequisites, the schedule, etc. The actual calculation or analytic logic may be defined in the template or it may be referenced. Thus, the calculation model can be used to describe and control the execution of a variety of different process models. Calculation templates can be linked with the asset templates such that when an asset (e.g., edge device 161a-161n) instance is created, any associated calculation instances are also created with their input and output parameters linked to the appropriate attributes of the asset (e.g., edge device 161a-161n).

The IoT platform 125 can support a variety of different analytics models including, for example, first principles models, empirical models, engineered models, user-defined models, machine learning models, built-in functions, and/or any other types of analytics models. Fault models and predictive maintenance models will now be described by way of example, but any type of models may be applicable.

Fault models are used to compare current and predicted enterprise 160a-160n performance to identify issues or opportunities, and the potential causes or drivers of the issues or opportunities. The IoT platform 125 includes rich hierarchical symptom-fault models to identify abnormal conditions and their potential consequences. For example, the IoT platform 125 can drill down from a high-level condition to understand the contributing factors, as well as determining the potential impact a lower level condition may have. There may be multiple fault models for a given enterprise 160a-160n looking at different aspects such as process, equipment, control, and/or operations. Each fault model can identify issues and opportunities in their domain, and can also look at the same core problem from a different perspective. An overall fault model can be layered on top to synthesize the different perspectives from each fault model into an overall assessment of the situation and point to the true root cause.

When a fault or opportunity is identified, the IoT platform 125 can make recommendations about the best corrective actions to take. Initially, the recommendations are based on expert knowledge that has been pre-programmed into the system by process and equipment experts. A recommendation services module presents this information in a consistent way regardless of source, and supports workflows to track, close out, and document the recommendation follow-up. The recommendation follow-up can be used to improve the overall knowledge of the system over time as existing recommendations are validated (or not) or new cause and effect relationships are learned by users and/or analytics.

The models can be used to accurately predict what will occur before it occurs and interpret the status of the installed base. Thus, the IoT platform 125 enables operators to quickly initiate maintenance measures when irregularities occur. The digital twin architecture of the IoT platform 125 can use a variety of modeling techniques. The modeling techniques can include, for example, rigorous models, fault detection and diagnostics (FDD), descriptive models, predictive maintenance, prescriptive maintenance, process optimization, and/or any other modeling technique.

The rigorous models can be converted from process design simulation. In this manner, process design is integrated with feed conditions and production requirement. Process changes and technology improvement provide business opportunities that enable more effective maintenance schedule and deployment of resources in the context of production needs. The fault detection and diagnostics include generalized rule sets that are specified based on industry experience and domain knowledge and can be easily incorporated and used working together with equipment models. The descriptive models identify a problem and then the predictive models can determine possible damage levels and maintenance options. The descriptive models can include models for defining the operating windows for the edge devices 161a-161n.

Predictive maintenance includes predictive analytics models developed based on rigorous models and statistic models, such as, for example, principal component analysis (PCA) and partial least square (PLS). Machine learning methods can be applied to train models for fault prediction. Predictive maintenance can leverage FDD-based algorithms to continuously monitor individual control and equipment performance. Predictive modeling is then applied to a selected condition indicator that deteriorates in time. Prescriptive maintenance includes determining what is the best maintenance option and when it should be performed based on actual conditions rather than time-based maintenance schedule. Prescriptive analysis can select the right solution based on the company's capital, operational, and/or other requirements. Process optimization is determining optimal conditions via adjusting set-points and schedules. The optimized set-points and schedules can be communicated directly to the underlying controllers, which enables automated closing of the loop from analytics to control.

The data insight layer 220 includes one or more components for time series databases (TDSB), relational/document databases, data lakes, blob, files, images, and videos, and/or an API for data query. When raw data is received at the IoT platform 125, the raw data can be stored as time series tags or events in warm storage (e.g., in a TSDB) to support interactive queries and to cold storage for archive purposes. Data can further be sent to the data lakes for offline analytics development. The data pipeline layer 215 can access the data stored in the databases of the data insight layer 220 to perform analytics, as detailed above.

The application services layer 225 includes one or more components for rules engines, workflow/notifications, KPI framework, insights (e.g., actionable insights), decisions, recommendations, machine learning, and/or an API for application services. The application services layer 225 enables building of applications 146a-d. The applications layer 230 includes one or more applications 146a-d of the IoT platform 125. For example, the applications 146a-d can include a buildings application 146a, a plants application 146b, an aero application 146c, and other enterprise applications 146d. The applications 146 can include general applications 146 for portfolio management, asset management, autonomous control, and/or any other custom applications. Portfolio management can include the KPI framework and a flexible user interface (UI) builder. Asset management can include asset performance and asset health. Autonomous control can include energy optimization and predictive maintenance. As detailed above, the general applications 146 can be extensible such that each application 146 can be configurable for the different types of enterprises 160a-160n (e.g., buildings application 146a, plants application 146b, aero application 146c, and other enterprise applications 146d).

The applications layer 230 also enables visualization of performance of the enterprise 160a-160n. For example, dashboards provide a high-level overview with drill downs to support deeper investigations. Recommendation summaries give users prioritized actions to address current or potential issues and opportunities. Data analysis tools support ad hoc data exploration to assist in troubleshooting and process improvement.

The core services layer 235 includes one or more services of the IoT platform 125. The core services 235 can include data visualization, data analytics tools, security, scaling, and monitoring. The core services 235 can also include services for tenant provisioning, single login/common portal, self-service admin, UI library/UI tiles, identity/access/entitlements, logging/monitoring, usage metering, API gateway/dev portal, and the IoT platform 125 streams.

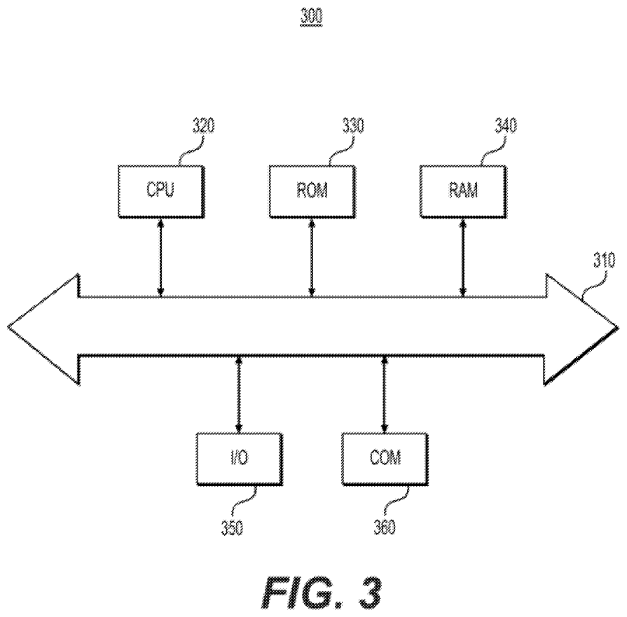

FIG. 3 depicts an example system 300 that is configured to perform and/or execute techniques presented herein. FIG. 3 is a simplified functional block diagram of a computer that may be configured to execute techniques described herein, according to exemplary embodiments of the present disclosure. Specifically, the computer (or “platform” as it may not be a single physical computer infrastructure) may include a data communication interface 360 for packet data communication. The platform also may include a central processing unit (“CPU”) 320, in the form of one or more processors, for executing program instructions. The platform may include an internal communication bus 310, and the platform also may include a program storage and/or a data storage for various data files to be processed and/or communicated by the platform such as ROM 330 and RAM 340, although the system 300 may receive programming and data via network communications. The system 300 also may include input and output ports 350 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

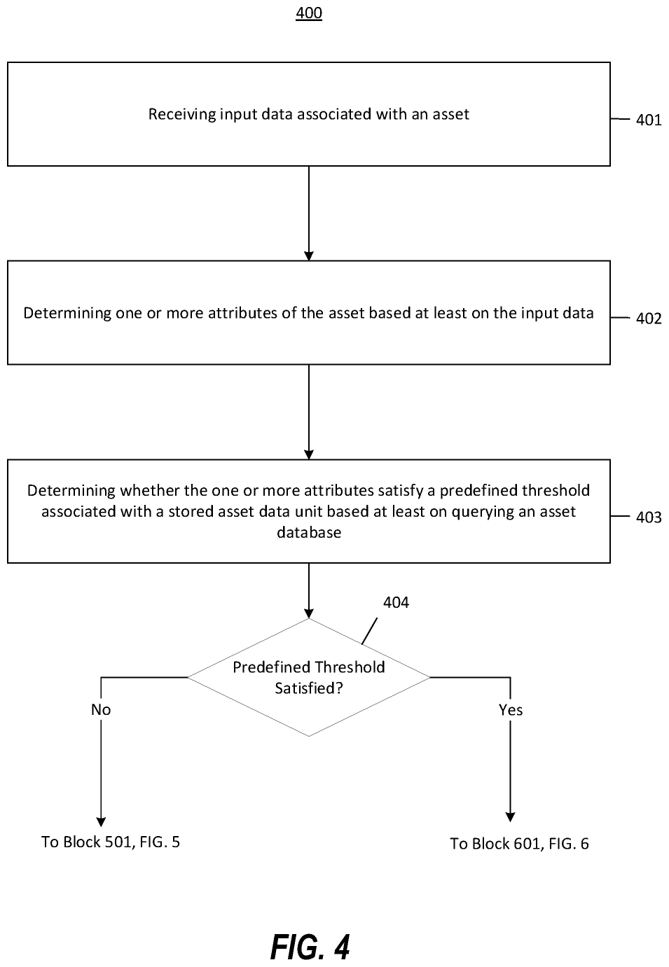

Referring now to FIG. 4, a method 400 illustrates operations performed related to determining and generating a digital twin or suggested digital twin based on receiving input data. In one or more embodiments, the method 400 begins at block 401 by receiving (e.g., by the CPU 320, communication interface 360, and/or the like) input data associated with an asset. In various embodiments, the input data comprises image data, sound data, or a combination of image and sound data.

In some embodiments, the input data is captured by a user device (e.g., a mobile device such as a mobile phone, tablet, laptop, and/or other device equipped or connected to a capture device such as a camera and/or microphone). For example, an engineer, technician, and/or other personnel may capture input data associated with an asset via the user device while physically next to an asset within an asset site (e.g., within a plant, warehouse, building, or the like). In some embodiments, the input data comprises image data. In this regard, the image data comprises an image of indicia located on or otherwise associated with the asset having been captured by the user device. For example, the indicia may comprise a label, tag, and/or the like located on or connected to the asset that comprises a barcode, QR code, and/or other scannable element.

In some embodiments, the input data comprises sound data. For example, the sound data comprises an audio stream and/or audio file having been captured by the user device. For example, in some embodiments, the sound data may comprises an audible description (e.g., spoken by a engineer, technician, and/or other personnel) of the asset. For example, the description may include various features of the asset, such as a name, model number, type, manufacturer, input and/or output connections, and/or the like.

In various embodiments, the input data further comprises metadata. In some examples, the metadata includes location data (e.g., location coordinates) of the user device at the time the input data was captured by the user device. In some embodiments, the metadata may include additional data such as information identifying the personnel operating the user device, information identifying the type and/or model of the user device, and/or the like.

In various embodiments, the input data may be captured by the user device via an application (e.g., a mobile “app”) executing on the user device. In some embodiments, the application is associated with the IoT platform 125 and configured to communicate data to and manage data associated with the IoT platform 125.

The method 400 also includes a block 402 that determines (e.g., by the CPU 320 and/or the like) one or more attributes of the asset based at least on the input data. For example, upon capture of the input data at the user device, the input data is communicated to the IoT platform 125 (e.g., via an edge gateway 162a-162n) and processed by one or more engines 143 to determine one or more attributes of the asset. For example, in some embodiments, the engines 143 comprise an image recognition engine and/or audio recognition engine configured to derive attributes from input data. For example, in circumstances in which input data comprising image data (e.g., an image of indicia such as a barcode and/or the like) is provided to the IoT platform, the image recognition engine processes the image to determine attributes of the asset based on the image. In this regard, the image recognition engine determines various attributes, such as make, model, serial number, manufacturer, and/or other attributes (e.g., vendor specific information, model number serial number, geo location of the asset, year/make, service dates, service SKU, and/or asset image) derivable from the indicia within the image.

In some embodiments, in circumstances in which input data comprising audio data (e.g., an audio stream and/or file of an audible description of an asset) is provided to the IoT platform, the audio recognition engine processes the audio data to determine attributes of the asset based on the image. In this regard, the image recognition engine determines various attributes, derivable from the audio description (e.g., via a speech-to-text process and/or the like).

The method 400 also includes a block 403 that determines (e.g., by the CPU 320 and/or the like) whether the one or more attributes satisfy a predefined threshold associated with a stored asset data unit based at least on querying an asset database. For example, in some embodiments, the databases 144 comprise an asset database (e.g., a catalog of assets and related tags). In some embodiments, the asset database comprises a plurality of asset data units. An asset data unit is a data structure comprising information about a particular asset that is stored in the asset database. For example, an example asset data unit may comprise known information related to a particular pump, such as the model and/or serial number of the pump, the brand name or vendor of the pump, what type of data sensors associated with the pump receive and/or transmit, geo location of the PUMP, year/make of the pump, service dates, service SKU, an asset image and/or other information related to the particular pump.

In some embodiments, querying the asset database comprises searching the asset database using the one or more attributes determined from the input data to determine whether information related to the asset is stored in the asset database. In some embodiments, the query may comprise a machine learning (ML)-based search such that one or more asset data units are provided as results for potential matches to the asset. In some examples, an ML-based search may include the use of an inferencing engine to categorize the kind of asset and lookup within the catalog assets of the same kind to identify the closest asset that matches the one that is scanned. Based on the number of attributes that match or accurately match (e.g., a confidence value), the rules based engine may determine the end result.

For example, in some embodiments, the asset data unit included in the results may each be associated with a confidence value indicating the likelihood of the asset matching the asset data unit. In some embodiments, the confidence value is a value between 0 and 1, with a value closer to 1 indicating a stronger match. In some embodiments, a predefined threshold is used in the ML search to determine a match of the asset to an asset data unit. For example, if the confidence value for a particular asset data unit meets or exceeds 0.85, it may be determined that the particular asset data unit is a match for the asset.

In some embodiments, in the event there is not a match (e.g., the search provides no results, or the results fail to meet the predefined threshold), the information related to the asset is automatically stored in the asset database for future searches. For example, the one or more attributes and/or image data is stored in the asset database as a new asset data unit. In this regard, the asset database is continuously updated with new asset data units as input data of assets is received. In some embodiments, the asset database is accessible by a plurality of entities (e.g., customers, enterprises, etc.) such that the asset database contains and is continuously updated with new asset data units from a plurality of asset sites associated with different customers, enterprises, and/or the like.

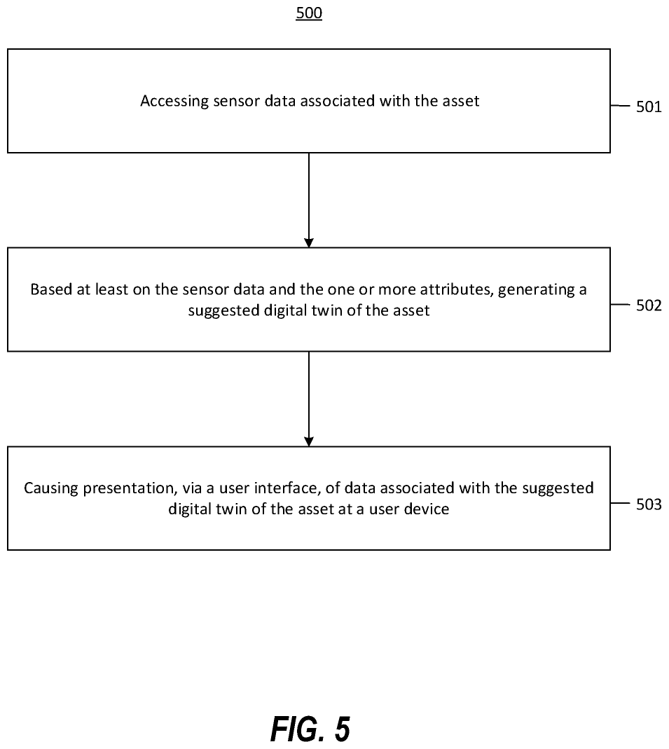

At decision point 404, in accordance with a determination that the one or more attributes do not satisfy the predefined threshold (e.g., confidence values of the asset data units in the results of the search do not meet or exceed the predefined threshold for a match), the method continues to block 501 of method 500, as shown in FIG. 5. As shown, block 501 accesses (e.g., by the CPU 320, communication interface 360, and/or the like) sensor data associated with the asset. For example, sensor data from sensors associated with the asset may be continuously collected by the IoT platform and processed by the models 142 and/or engines 143. For example, in some embodiments, the models 142 and/or engines 143 comprise a contextual discovery model (e.g., one or more contextual discovery algorithms) and one or more rules configured to process and infer types of assets based on raw data such as sensor data and/or based on tagged data. In some examples, the contextual discovery model may comprise a listing of As one example, the contextual discovery model may process an example sensor data point comprising a minimum-to-maximum value range of 1000 to 5000 and determine that the data point is indicative of an revolutions-per-minute (RPM) reading.

In some embodiments, the sensor data is accessed and applied in combination with the one or more attributes determined from the input data to the contextual discovery model to determine a suggested digital twin for the asset. In this regard, the method 500 also includes a block 502 that generates (e.g., by the CPU 320 and/or the like), based at least on the sensor data and the one or more attributes, a suggested digital twin of the asset. The suggested digital twin comprises a digital twin of an asset most likely to match the asset associated with the input data. For example, in some embodiments, by additionally using sensor data, a confidence score of an asset data unit may increase to meet or exceed the predefined threshold.

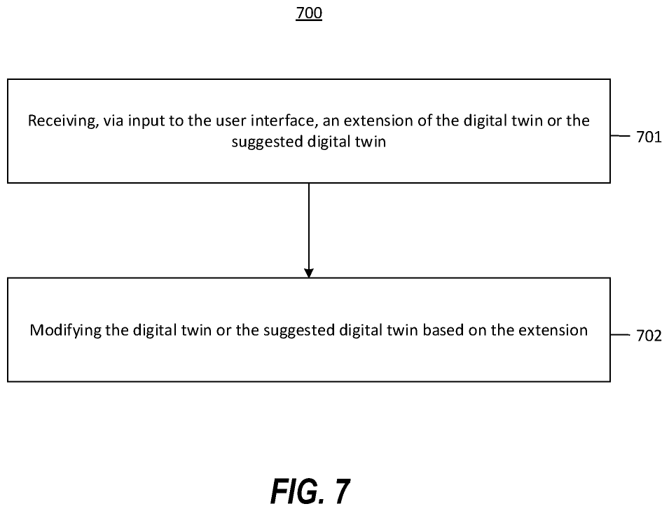

The method 500 also includes a block 503 that causes (e.g., by the CPU 320, communication interface 360, and/or the like) presentation, via a user interface, of data associated with the suggested digital twin of the asset at a user device. For example, information regarding the suggested digital twin (e.g., attributes, data points, input/output data, etc.) may be displayed at the user device from which the input data was captured. In this regard, a user of the user device is provided with a suggested digital twin after scanning a label of the asset or capturing an audible description of the asset in real-time or near real-time. In some embodiments, input in the form of an extension (e.g., an addition or modification) of the suggested digital twin may be received via input at the user interface. Operations related to the extension of a digital twin or suggested digital twin is further described below in connection with FIG. 7.

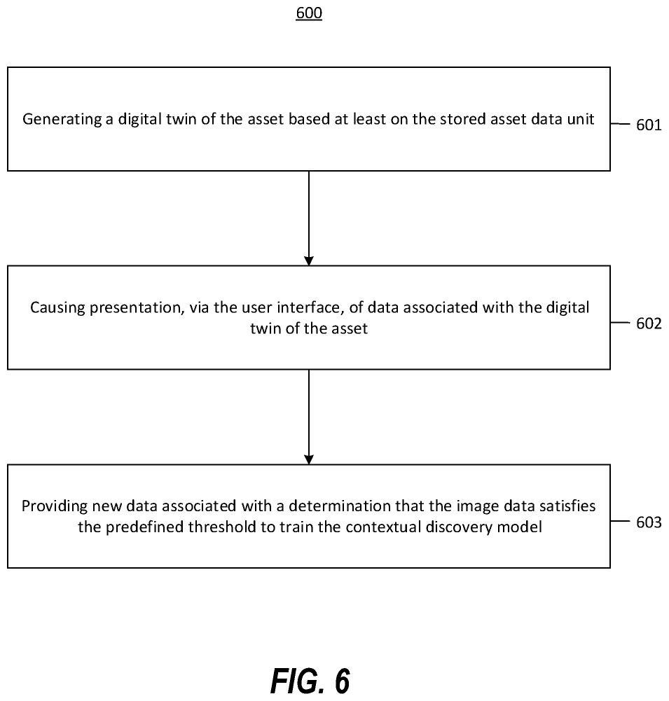

Returning to FIG. 4, at decision point 404, in accordance with a determination that the one or more attributes satisfy the predefined threshold (e.g., a confidence value of at least one asset data unit meets or exceeds the predefined threshold), the method continues to block 601 of method 600, as shown in FIG. 6. As shown, block 601 generates (e.g., by the CPU 320 and/or the like) a digital twin of the asset based at least on the stored asset data unit. In this regard, a digital twin of the asset is created using the information stored in the asset data unit. The method 600 also includes a block 602 that causes (e.g., by the CPU 320, communication interface 360, and/or the like) presentation, via the user interface, of data associated with the digital twin of the asset. For example, information regarding the digital twin (e.g., attributes, data points, input/output data, etc.) may be displayed at the user device from which the input data was captured. In this regard, a user of the user device may be provided with a digital twin after scanning a label of the asset or capturing an audible description of the asset in real-time or near real-time. In some embodiments, input in the form of an extension (e.g., addition or modification) of the suggested digital twin may be received via input at the user interface.

The method also includes a block 603 that provides (e.g., by the CPU 320, communication interface 360, and/or the like) new data associated with a determination that the one or more attributes satisfy the predefined threshold to train the contextual discovery model. For example, in some embodiments, additional training data is generated based on the identification of the asset and used to train the contextual discovery model.

Turning to FIG. 7, a method 700 for extending a digital twin or suggested digital twin is shown. The method 700 includes a block 701 that receives (e.g., by the CPU 320, communication interface 360, and/or the like) via input to the user interface, an extension of the digital twin or the suggested digital twin. For example, upon information regarding the digital twin (e.g., attributes, data points, input/output data, etc.) being displayed at the user device, a user of the user device can modify the information to more accurately represent the asset as a digital twin. For example, the user may rename one or more properties of the asset, add, remove or modify one or more properties of the asset, modify input and/or output data, add or modify connections (e.g., other assets the asset may be in communication with), and/or the like.

The method 700 also includes a block 702 that modifies (e.g., by the CPU 320, and/or the like) the digital twin or the suggested digital twin based on the extension. For example, in some embodiments, upon receiving the extension provided by the user, the IoT platform 125 modifies the suggested digital twin in accordance with the extensions made by the user. For example, the one or more attributes that were extended by a user via the user interface are updated and stored in association with the digital twin. In some embodiments, the digital twin is then stored (e.g., by the CPU 320 and/or the like) in association with at least one additional digital twin of a shared asset site.

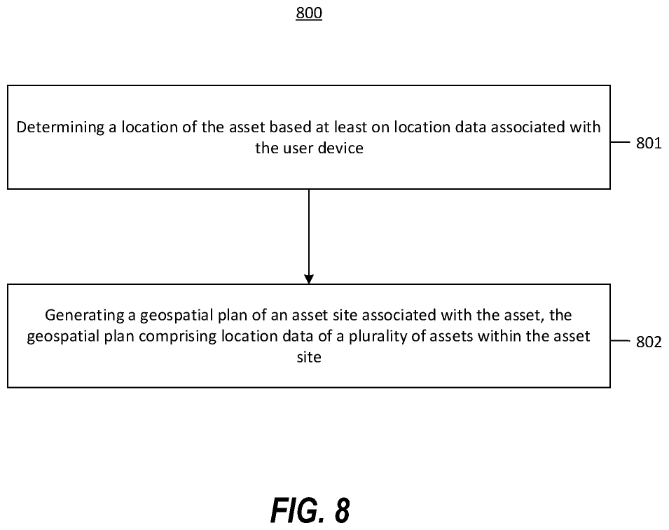

Turning to FIG. 8, a method 800 for generating a geospatial plan of an asset site is shown. The method 800 includes a block 801 that determines (e.g., by the CPU 320 and/or the like) a location of the asset based at least on location data associated with the user device. For example, in some embodiments, location data of a user device is used to determine a location of an asset within an asset site. In this regard, GPS-based location data of a user device is collected and associated with a digital twin of an asset which the user device has captured input data of For example, a user standing next to a particular asset may capture an image of the particular asset with a user device. Location data of the user device is then collected and used to associate the particular asset with a real-world location (e.g., the location of the user device).

The method 800 also includes a block 802 that generates (e.g., by the CPU 320 and/or the like) a geospatial plan of an asset site associated with the asset, the geospatial plan comprising location data of a plurality of assets within the asset site. For example, in some embodiments, a geospatial plan of an asset site comprises a visualization which is rendered to a user interface (e.g., the user interface of a user device) that provides a visual layout of an asset site with locations of assets indicated in the layout. By generating a geospatial plan providing a visual layout of asset locations within a site as well as the ongoing development of a catalog of assets, an onboarding speed of digital twins is further improved, as connections between the assets can be inferred based on the visual layout and in view of the catalog.

In some example embodiments, certain ones of the operations herein can be modified or further amplified as described below. Moreover, in some embodiments additional optional operations can also be included. It should be appreciated that each of the modifications, optional additions or amplifications described herein can be included with the operations herein either alone or in combination with any others among the features described herein.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms “first,” “second,” etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not, the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise, It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including,” and variants thereof are used in either the detailed description or the claims, these terms are intended to be inclusive in a manner similar to the term “comprising.”

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

What is claimed is:

1. A method comprising:
receiving input data associated with an asset;
determining one or more attributes of the asset based at least on the input data;
determining whether the one or more attributes satisfy a predefined threshold associated with a stored asset data unit based at least on querying an asset database;
in accordance with a determination that the one or more attributes do not satisfy the predefined threshold:
accessing sensor data associated with the asset;
based at least on the sensor data and the one or more attributes, generating a suggested digital twin of the asset; and
causing presentation, via a user interface, of data associated with the suggested digital twin of the asset at a user device.

2. The method of claim 1, further comprising:
in accordance with a determination that the one or more attributes satisfy the predefined threshold:
generating a digital twin of the asset based at least on the stored asset data unit; and
storing the digital twin of the asset in association with at least one additional digital twin of a shared asset site.

3. The method of claim 2, further comprising:
causing presentation, via the user interface, of data associated with the digital twin of the asset.

4. The method of claim 1, the generating of the suggested digital twin comprising applying the sensor data and the one or more attributes to a contextual discovery model to determine one or more suggested digital twins of the asset.

5. The method of claim 4, the method further comprising:
providing training data associated with a determination that the one or more attributes satisfy the predefined threshold to the contextual discovery model.

6. The method of claim 1, the method further comprising:
receiving, via input to the user interface, an extension of the suggested digital twin;
modifying the suggested digital twin based on the extension.

7. The method of claim 1, the input data being received from the user device.

8. The method of claim 7, the input data comprising image data captured by the user device.

9. The method of claim 8, the image data comprising an image of indicia associated with the asset.

10. The method of claim 7, the input data comprising sound data captured by the user device.

11. The method of claim 1, further comprising:
determining a location of the asset based at least on location data associated with the user device.

12. The method of claim 11, further comprising:
generating a geospatial plan of an asset site associated with the asset, the geospatial plan comprising location data of a plurality of assets within the asset site.

13. A system, comprising:
a processor; and
a memory that stores executable instructions that, when executed by the processor, cause the processor to:
receive input data associated with an asset;
determine one or more attributes of the asset based at least on the input data;
determine whether the one or more attributes satisfy a predefined threshold associated with a stored asset data unit based at least on querying an asset database;
in accordance with a determination that the one or more attributes do not satisfy the predefined threshold:
access sensor data associated with the asset;
based at least on the sensor data and the one or more attributes, generate a suggested digital twin of the asset; and
cause presentation, via a user interface, of data associated with the suggested digital twin of the asset at a user device.

14. The system of claim 13, the executable instructions being further configured to, when executed by the processor, cause the processor to:
in accordance with a determination that the one or more attributes satisfy the predefined threshold:
generate a digital twin of the asset based at least on the stored asset data unit; and
store the digital twin of the asset in association with at least one additional digital twin of a shared asset site.

15. The system of claim 14, the executable instructions being further configured to, when executed by the processor, cause the processor to:
cause presentation, via the user interface, of data associated with the digital twin of the asset.

16. The system of claim 13, the executable instructions configured to generate the suggested digital twin being further configured to, when executed by the processor, cause the processor to apply the sensor data and the one or more attributes to a contextual discovery model to determine one or more suggested digital twins of the asset.

17. The system of claims 16, the executable instructions being further configured to, when executed by the processor, cause the processor to:
provide training data associated with a determination that the one or more attributes satisfy the predefined threshold to the contextual discovery model.

18. The system of claim 13, the executable instructions being further configured to, when executed by the processor, cause the processor to:
receive, via input to the user interface, an extension of the suggested digital twin;
modify the suggested digital twin based on the extension.

19. The system of claim 13, the executable instructions being further configured to, when executed by the processor, cause the processor to:
determine a location of the asset based at least on location data associated with the user device.

20. A non-transitory computer-readable storage medium comprising one or more programs for execution by one or more processors of a device, the one or more programs including instructions which, when executed by the one or more processors, cause the device to:
receive input data associated with an asset;
determine one or more attributes of the asset based at least on the input data;
determine whether the one or more attributes satisfy a predefined threshold associated with a stored asset data unit based at least on querying an asset database;
in accordance with a determination that the one or more attributes do not satisfy the predefined threshold:
access sensor data associated with the asset;
based at least on the sensor data and the one or more attributes, generate a suggested digital twin of the asset; and
cause presentation, via a user interface, of data associated with the suggested digital twin of the asset at a user device.
